(19) United States
(12) Patent Application Publication
(10) Pub. No.: US 2008/0075254 A1
(43) Pub. Date: Mar. 27, 2008

(54) Contacting identified service provider after connection by consumer via free information service

(75) Inventor: Scott A. Kliger, Franklin, MI (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Jingle Networks, Inc., Burlington, MA (US)

(21) Appl. No.: 11/516,459

(22) Filed: Sep. 5, 2006

(51) Int. Cl. H04M 3/42

(52) U.S. Cl. 379/201.01

(57) ABSTRACT

A platform for contacting an identified service provider after connection by a consumer via a free information service allows the free information service to generate additional advertising sales leads. After the free information service contacts the identified service provider and connects the calls between the consumer and the identified service provider, a sales representative of the free information service contacts the identified service provider to solicit advertising sales from the identified service provider. Further, upon connecting the call between the consumer and the identified service provider, a message may be played to the identified service provider informing the identified service provider that it is receiving the call from the consumer as a result of the directory assistance provided by the free information service, thereby demonstrating to the identified service provider that the platform is successful and motivating the identified service provider to buy advertising with the free information service.

### BACKGROUND OF THE INVENTION

Telephone directory assistance continues to be an extremely important service for consumers and businesses. It is estimated that in 2004 there will be approximately 8 billion telephone calls placed to directory assistance services (i.e., 411, 555-1212) in the United States. The average cost billed to consumers for these calls is now in excess of $1.00.

Directory assistance services are thus an enormous revenue center for both wired and wireless carriers, with profit margins rumored to be in the 90% range. Nearly all directory assistance calls that are placed by consumers are those looking for a phone number for a specific business or individual that traditionally could be found manually in the “white pages.”

To date there truly is no comprehensive telephone-based directory assistance available. In particular, consumers may be looking for a business for which they know a category (i.e., plumber, lawyer, travel agent, taxi, etc.) but for which they do not know a name and/or location. There is also no way for a consumer to use a telephone to search by “keyword” for a product or service they wish to purchase. These types of searches are still reserved for consumers to use traditional sources, such as the “yellow pages.” Increasingly now, consumers can also turn to internet-based online directories and search engines for this type of search.

However, such directory searches often tend to be local in nature, meaning that the consumer is actually looking for a merchant in their immediate geographic area. It is this reality which has driven the two largest internet search engine advertising platforms, Google and Overture (a Yahoo! subsidiary), to recently launch localized advertising options for their so called Cost Per Click (CPC)-based advertising services.

There has recently, of course, been much attention paid to online keyword search market. Yahoo!'s acquisition of Overture in July 2003 for $1.6 billion has led to a doubling of Yahoo!'s market capitalization, recently at $15 billion. Google's Initial Public Offering (IPO) in August 2004 valued the company at over $23 billion. Almost all of Google's revenue is derived from their “AdWords” paid search product. Both Microsoft and America Online are aggressively entering the marketplace with their own online search solutions. Current estimates are that online paid keyword search market will reach $5.5 billion in 2009.

But the reality is that of the 13 million small- to medium-sized businesses in the United States, fewer than 300,000 of them advertise using web-based services (see Jupiter Research, Pay Per Call Survey, March, 2004). The reasons for this are many, but include at least the fact that, in order to advertise successfully online, a business must have both a viable website presence as well as the technical infrastructure to be able to handle the leads they receive, typically via e-mail. Furthermore, businesses need to have technical savvy in order to be able to create and manage one or more paid search campaigns. Perhaps it is for these reasons alone that businesses spent 46% of their advertising budget on yellow pages ads but only about 3% for internet search advertising.

While a cottage industry of search engine marketing companies has developed in order to bring more and more businesses online with paid search, the reality is that the majority of businesses are left out. Other reasons for this include the fact that, because of the global nature of the internet, paid keyword search is more effective for products and services which do not require contact with a local market. Furthermore, because of the bidding process for placement of paid advertisements, many small businesses are “squeezed out” of the internet search market by large, national players who can afford to pay more in order to capture online leads.

The majority of small businesses thus still rely primarily on the telephone as their primary means of generating sales leads. However, it is often difficult to convince local businesses to enroll in a service, especially an advertising service. Although the yellow pages offers businesses a certain level of credibility, that credibility is losing much of its weight as newer technologies, such as online advertising, become more prominent. In an era where personal video recorders threaten to alter the landscape of television advertising, commercial-free satellite radio systems limit the effectiveness of local radio advertising, and the national “Do Not Call Registry” has effectively eliminated traditional telemarketing, merchants and service providers looking to market themselves locally are actually becoming more limited in their choices.

### SUMMARY OF THE INVENTION

The present invention is a technology platform for the delivery of advertising supported information services. More specifically, the invention provides business owners the ability to advertise via a free information service and illustrates to the business, by direct example, how such advertising can be successful. By connecting a consumer, who is likely ready to purchase goods or secure services, to the business for free and allowing the business to offer its goods and services to the consumer, the technology platform is able to explicitly demonstrate to the business the benefits of its services before soliciting the business to be included in the listings database and ads server.

In one specific embodiment, at a customer station, a consumer dials an information access telephone number and a call is connected to a call processing station. The call processing station then queries the consumer and receives a request for information from the consumer, and responds thereto by identifying a service provider. A database is then queried to determine whether it contains an entry for the identified service provider. A call is then connected from the call processing station to the identified service provider and is then handed off to the consumer. The call connection from the consumer to the call processing station is then terminated.

If the database did not contain an entry for the identified service provider then the call processing system connects a call to the identified service provider after the call connection between the customer station and the identified service provider station is terminated. This call may be made for the purpose of soliciting advertising sales from the identified service provider.

In another embodiment, a notification message can be forwarded to the identified service provider station, identifying the call processing station as the originator of the call and responsible for referring the consumer to the identified service provider. This notification message can be forwarded to the identified service provider station in an audible form or a visual form. If the notification message is in audible form it can be forwarded to the identified service provider station in such a way that it is not audible to the customer station.

In yet a further embodiment, the call processing station may place its sales solicitation call to the identified service provider station a predetermined amount of time following the termination of the call connection from the customer station to the identified service provider station. In another embodiment, the call processing station may place its sales solicitation call to the identified service provider station immediately following the termination of the call connection from the customer station to the identified service provider station.

Audio advertisements provide for a level of interactivity which enables a new set of functions between advertisers and consumers. The platform can thus be used for a number of novel services. As one example, a Pay Per Call (PPC) service can be provided that supports a “free to consumer” telephone-based yellow pages-type directory search. Advertisers will be attracted to this service because they will only be charged if a consumer actually reaches them in order to inquire or purchase their products or services. Unlike an internet search, in which a consumer is typically researching only a future potential purchase, a yellow pages search is typically conducted when a consumer is serious about making a purchase. Therefore, these leads tend to be quite valuable to advertisers. Also, unlike internet-based pay per click advertising, which is limited to technology-savvy advertisers and service providers who have a website, the invention provides a service that can be made available to any merchant familiar with telephones.

Because the consumer doing a yellow pages-type search has almost always made a decision to purchase prior to engaging such a search, calls generated from a telephone-based yellow pages search can be quite valuable. A minimum cost per call can thus be greater than the cost of directory service and supported by advertisers. The actual amount charged can depend upon the competitiveness of the marketplace and the actual value of the consumer lead for a specific category or keyword. The amounts could be as high, or higher in some instances, as valuable pay per click keywords on the internet.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high level diagram of a system that solicits advertising from an identified service provider in response to a consumer initiated request for information.

FIGS. 2a and 2b are flow charts of the steps performed by the system when it successfully determines that an identified service provider is included in a listings database and the steps performed by the system to solicit advertising from an identified service provider when the system determines that the listings database does not contain an entry for the identified service provider, respectively.

### DETAILED DESCRIPTION OF THE INVENTION

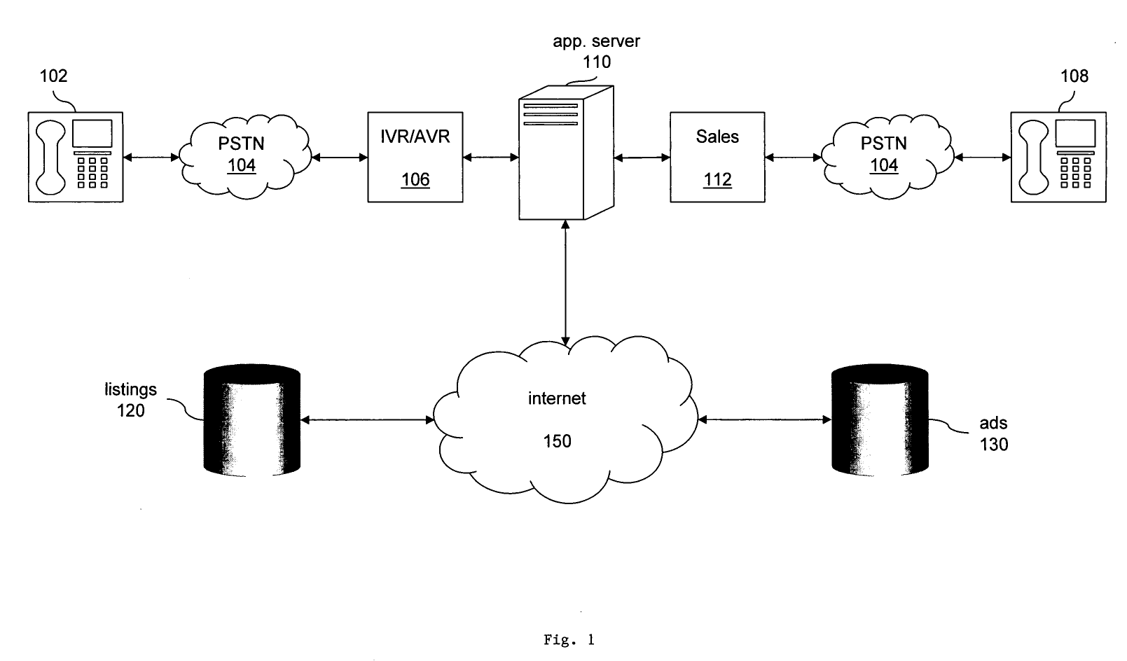

Now to describe technical aspects of one preferred embodiment of the invention. With reference to FIG. 1, the invention can be implemented using an application server 110 which can receive information originating from a Public Switched Telephone Network (PSTN) 104, specifically via a call originating from a consumer who is using a telephone 102.

The server 110 can receive information requests as data in many ways. In one preferred arrangement, the information is provided via an Interactive Voice Response (IVR)/Automated Voice Recognition (AVR) system 106. The IVR portion of system 106 has some type of interface to obtain a search request from the user, and provide the request as data. For example, the information request can be provided in data form via a keypad (Dual Tone Multi-Frequency (DTMF) digits), by voice recognition software that recognizes speech, and/or via a live operator who speaks to the consumer live and then keys in the request as text. The AVR portion of system 106 provided automatic recognition of the voice signals provided by the consumer.

The application server 110 is connected through the internet 150 (and/or local networks) to various other databases and/or information servers. These include, for example, a listings database 120, an ad server 130, and other possible paid-subscription or free services or databases. FIG. 1 should be considered a logical view of the various databases; that is, although the drawings illustrates these databases as individual discrete entities each having their own server, it should be understood that one, several, or all of the databases may be consolidated in one physical machine, or that one or more of the databases may be so large as to be distributed among multiple servers and physical processors and/or disk drives.

In general, the application server 110 crafts a search query from the information supplied by the consumer via the telephone 102. The information is then packaged as part of a search query submitted to the private listings database 120. The listings 120 database contains information concerning advertisers who have paid a fee to be listed in the system or agreed to pay for each call which is directed to them as the result of a consumer inquiry.

Through a series of interactive events as described in a related application, U.S. patent application Ser. No. 11/291,094, Telephone Search Supported By Keyword Map To Advertising, filed Nov. 29, 2005, the application server 110 identifies a service provider requested by the consumer. The consumer can then hear an advertisement for a competing product, a completely different product, or no advertisement at all, and can be connected to the requested business or can be connected to a competing, advertising business, as determined by the consumer.

A successful query in the listings database 120 identifies one or more businesses that have purchased an advertisement to be stored in the ads server 130. An unsuccessful query in the listings database 120 identifies a business that has not purchased an advertisement to be stored in the ads server 130. The existence of this unlisted business is forwarded to sales department 112 as a sales lead so that the business may be solicited to be included in the listings database 120 and an advertisement from the business may be included in the advertising server 130.

Following the termination of the call connection between the consumer telephone 102 and the business telephone 108, a sales representative 112 may place a call, or the application server 110 may initiate the call connection, over the PSTN 104 to the business telephone 108. [NOTE: Could it also be that after the call, but before the service provider hangs up, the system announces something like “Please hold for an important message from 1 800 FREE 411”?] During this call connection, the sales representative 112 may make its sales pitch to the business and express to the business that the technology platform is credible by reminding the business that a customer has already been referred to the business through the service.

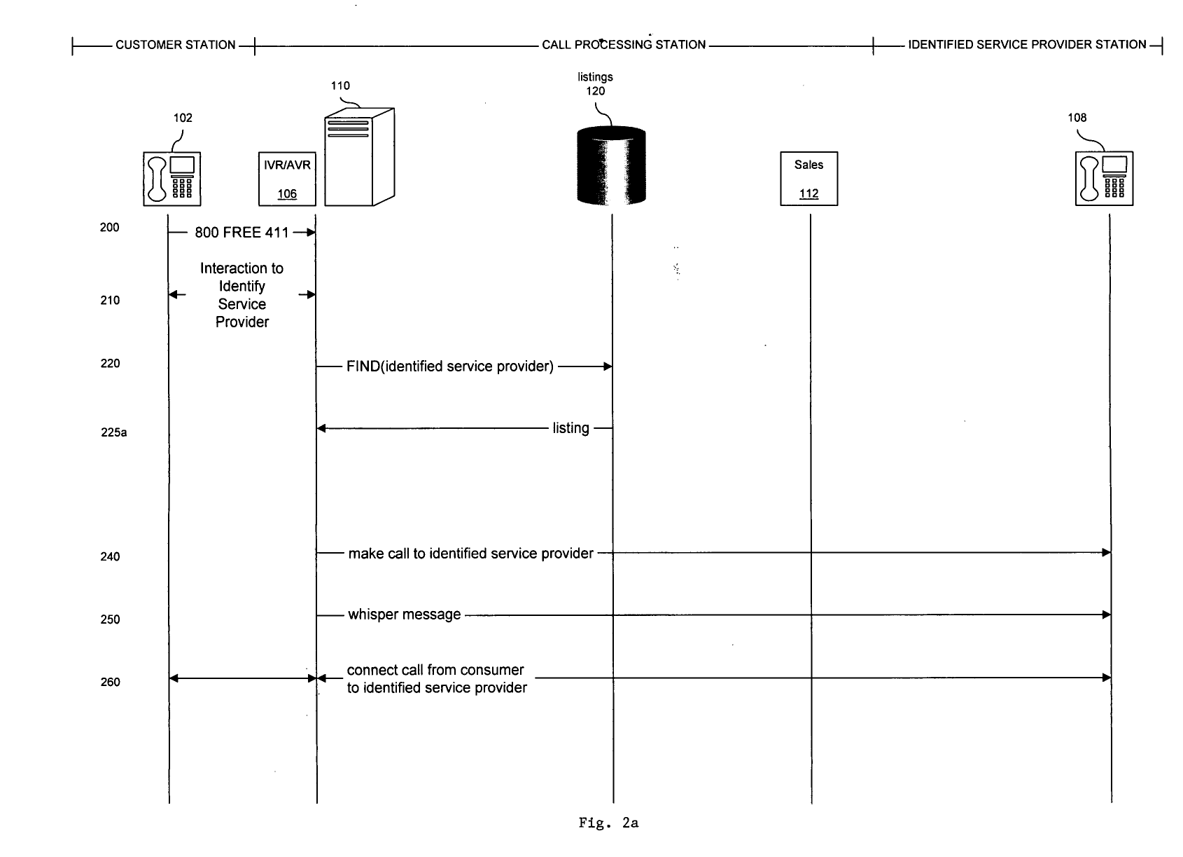

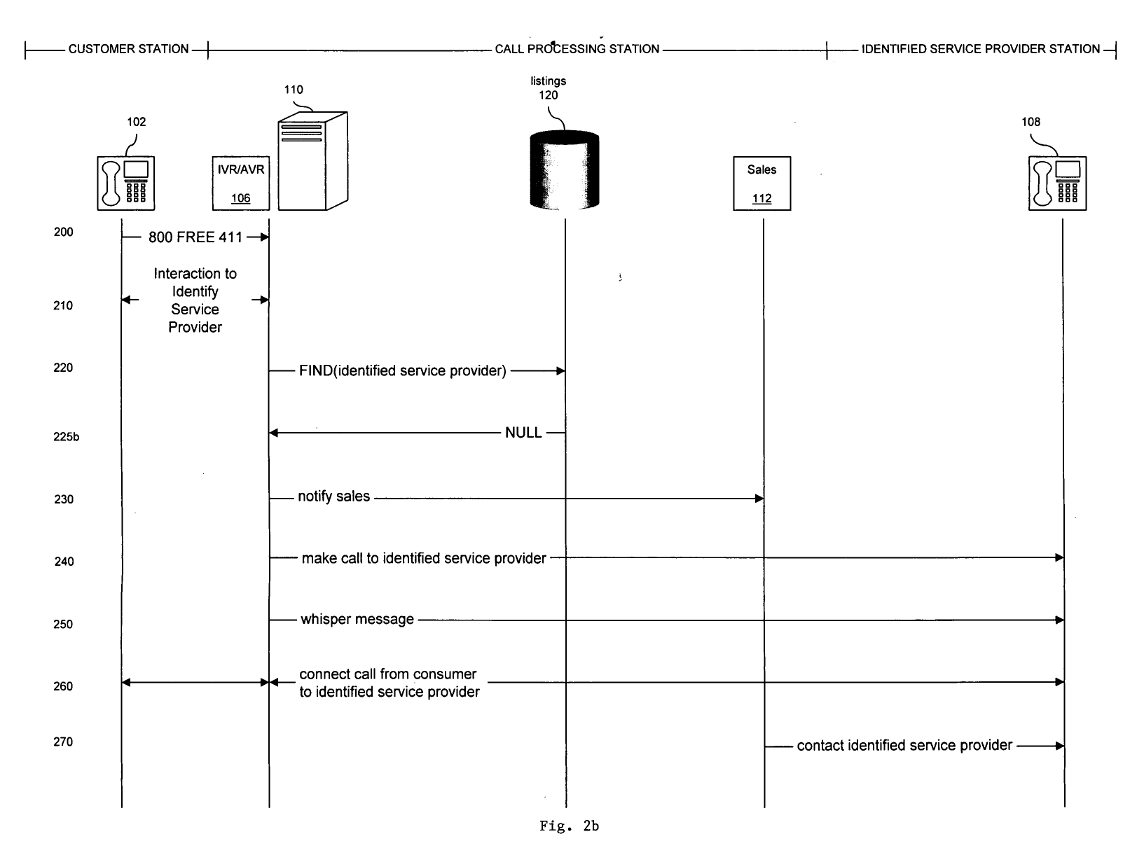

FIGS. 2a and 2b illustrate examples of how a request may be processed by the system in more detail. Certain components of the system of FIG. 1 are listed across the top of the page, with a sequence of steps detailed beneath them.

In both figures, the consumer is using a telephone 102. In a first step 200, the consumer uses the telephone 102 to dial the ad-supported information service, such as by dialing a toll-free 800 number. Once the call is connected, in step 210, there is a series of interactive events 210 as described in a related application, U.S. patent application Ser. No. 11/291,094, Telephone Search Supported By Keyword Map To Advertising, filed Nov. 29, 2005. After a service provider is identified by the application server 110 and selected by the user 102, the application server 110 queries 220 the listings database 120 to determine whether there is an entry for the identified service provider.

In FIG. 2a, a successful query 220 to the listings database 120 returns a listing 225a, indicating that the ads server 130 holds an advertisement for the identified service provider. The application server 110 then makes a call 240 to the identified service provider 108 and plays a whisper message 250, identifying the call from the consumer 102 as having originated through the advertising-supported information service. The application server 110 then connects 260 the call from the consumer 102 to the identified service provider 108.

However, as in FIG. 2b, if the listings database 120 is unable to return a listing 225b from the query 220, the application server 110 notifies a sales representative 112 that the identified service provider is an advertising sales lead. The application server 110 then proceeds as in FIG. 2a, making a call 240 to the identified service provider 108 and playing a whisper message 250, identifying the call from the consumer 102 as having originated through the advertising-supported information service. The application server 110 then connects 260 the call from the consumer 102 to the identified service provider 108.

Following the termination of the call 260 between the consumer 102 and the identified service provider 108, the sales representative 112 contacts 270 the identified service provider 108 to solicit advertising sales from the identified service provider 108. Through this advertising, the identified service provider 108 will be included in the listings database 120 and will have a recorded advertisement included in the ad server 130.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for use in a telecommunications network, the network comprising a customer station, a call processing station and an identified service provider station, the method comprising the steps of:
at the customer station,
(a) dialing a telephone number used for accessing the call processing station;
(b) setting up a call connection from the customer station to the call processing station;
(c) providing a request for information from the customer station;
at the call processing station,
(d) receiving the request for information from the customer station;
(e) responding to the request for information;
(f) determining whether a database has an entry for the identified service provider;
(g) setting up a call connection from the call processing station to the identified service provider station;
(h) handing off to the customer station the call connection from the call processing station to the identified service provider station;
(i) terminating the call connection from the customer station to the call processing station;
(j) if the database does not contain an entry for the identified service provider, then setting up a call connection from the call processing station to the identified service provider station.

2. A method as in claim 1 additionally comprising:
at the call processing station,
(j) forwarding a notification message to the identified service provider station;

3. A method as in claim 2 additionally comprising:
at the identified service provider station,
(k) receiving the notification message.

4. A method as in claim 3 additionally comprising the step of:
(l) causing the notification message to be played to the identified service provider station in an audible form.

5. A method as in claim 4 wherein the notification message is not audible to the customer station.

6. A method as in claim 2 wherein the notification message identifies the call processing station as responsible for the call to the identified service provider station.

7. A method as in claim 3 additionally comprising the step of:
(m) causing the notification message to be played to the identified service provider in a visual form.

8. A method as in claim 1 wherein the request for information includes a description of a product or service.

9. A method as in claim 1 wherein the step of setting up a call connection from the call processing station to the identified service provider station when the database does not have an entry for the identified service provider is performed a predetermined amount of time following the termination of the call connection from the customer station to the identified service provider station.

10. A method as in claim 9 wherein the step of setting up a call connection from the call processing station to the identified service provider station when the database does not have an entry for the identified service provider is performed immediately following the termination of the call connection from the identified service provider station to the customer station.

11. A method as in claim 1 wherein the step of setting up a call connection from the call processing station to the identified service provider station when the database does not have an entry for the identified service provider is performed for the purpose of soliciting advertising sales from the identified service provider.
